(19) United States
(12) Patent Application Publication
(10) Pub. No.: US 2025/0101268 A1
(43) Pub. Date: Mar. 27, 2025

(54) COMPOSTABLE OR BIODEGRADABLE PRESSURE SENSITIVE ADHESIVE BASED ON POLYURETHANE

(71) Applicants: Henkel AG & Co. KGaA, Duesseldorf (DE); HENKEL IP & HOLDING GMBH, Duesseldorf (DE)

(72) Inventor: Yayun Liu, Warren, NJ (US)

(21) Appl. No.: 18/716,001

(22) PCT Filed: Nov. 22, 2022
(86) PCT No.: PCT/US2022/080310

§ 371 Date: Jun. 3, 2024

Related U.S. Application Data
(60) Provisional application No. 63/381,781, filed on Nov. 1, 2022.
(60) Provisional application No. 63/287,206, filed on Dec. 8, 2021.

(51) Int. Cl. C09J 7/38; C09J 11/08

(52) U.S. Cl. CPC C09J 7/38; C09J 11/08; C09J 2203/334; C09J 2301/302; C09J 2301/408

(57) ABSTRACT

This invention relates to a compostable or a substantially biodegradable pressure sensitive adhesive that contains at least one biodegradable polyurethane, at least one biodegradable tackifier and optionally at least one plasticizer.

### TECHNICAL FIELD

This disclosure relates generally to pressure sensitive adhesives that are biodegradable. More particularly, this disclosure relates generally to pressure sensitive adhesives that are biodegradable and compostable.

### BACKGROUND OF THE INVENTION

This section provides background information which is not necessarily prior art to the inventive concepts associated with the present disclosure.

In response to the growing challenges of plastic waste to the environment, there is a need to increase recycling and reuse. Composting is nature's way of recycling, where organic materials are broken down by microbes in the soil and the nutrients they contain will be part of the soil like humic substance, called compost. Compostable products by definition are biodegradable. However, compostable products must also break down, or become part of usable, soil-enhancing compost in a safe and timely manner in an appropriate composting facility or home compost pile. To ensure quality of the compost and increase the amount of compostable waste, there is a need to have most food packaging materials be compatible with various composting requirements.

Various certification and labelling schemes for home and industrial compostable packaging materials exist. Industry accepted industrial composting standards include ASTM D6400:2000—Standard Specification for Compostable Plastics, ISO 17088:2008-Specification for Compostable Plastics, EN 13432-—Packaging—Requirements for packaging recoverable through composting and biodegradation—Test scheme and evaluation criteria for the final acceptance of packaging and AS 4736:2006—Biodegradable plastics—Biodegradable plastics suitable for composting and other microbial treatment.

Many have attempted to use biodegradable polymer to create a compostable or biodegradable pressure sensitive adhesive (PSA). Such efforts use polylactic acid (PLA) and sulfonated copolyester to create hotmelt adhesive for beverage cups (U.S. 20200079981). The limitation of this approach is that PLA has poor thermal stability and high moisture sensitivity. It is not suited for many food packaging applications exposed to varying temperature and humidity conditions. Others have used bio-based materials such as epoxidized soybean oil (EP3089868) to make compostable water-based adhesive, however the performance is undesirably limited.

Biodegradable polyurethane (PUR) has been used to develop compostable or biodegradable PSA, such as aliphatic polyester polyol polyurethane used as solvent borne PSA (U.S. Pat. No. 6,307,003), or PUR reactive hotmelt adhesive based on polyester polyol polyurethane (EP3155034). These approaches offer broad performance but with limited application due to volatile organic compound (VOC) issues and specific application requirements. Moreover, available PUR dispersions are not tacky or soft at room temperature and do not have adhesive properties.

Currently available fruit or produce labels are made of paper or plastic facestock coated with a layer of pressure sensitive adhesive (PSA). A PSA is a type of adhesive that is aggressively and permanently tacky at room temperature and firmly adheres to a variety of dissimilar surfaces with application of low pressure. Currently, PSAs are typically formulated from acrylates, silicone, synthetic rubber and isoprenes, however none of these compounds are readily compostable.

### SUMMARY OF THE DISCLOSURE

This section provides a general summary of the disclosure and is not a comprehensive disclosure of its full scope or all features, aspects or objectives.

The inventive disclosure includes a compostable, pressure sensitive adhesive composition including: (1) an aliphatic polyester polyurethane (PPU) aqueous dispersion including an aliphatic polyester polyurethane made from an aliphatic polyol and an aliphatic isocyanate, the aliphatic polyester polyurethane having a molecular weight of from about 10,000 to about 1million (M) and a Tg less than about −10° C.; the aliphatic polyester polyurethane being substantially amorphous at the application temperature of the aliphatic polyester (PPU) aqueous dispersion to a substrate; and (2) a biodegradable rosin ester tackifier; wherein the biodegradable rosin ester tackifier is present in an amount sufficient to provide a peel strength of at least about 0.5 pounds per linear inch at room temperature; and wherein the pressure sensitive adhesive composition is at least 90% biodegradable after being contained in an enclosure which is incubated in the dark or in diffuse light for 365 days or less at a temperature from about 19° C. to about 26° C. or for 180 days at a temperature from about 56° C. to about 60° C.

The inventive disclosure includes the compostable pressure sensitive adhesive composition wherein the rosin ester tackifier is present in the compostable pressure sensitive adhesive in an amount sufficient to provide a peel strength of from about 0.5 pounds per linear inch at room temperature to about 1.3 pounds per linear inch at room temperature.

The inventive disclosure includes the compostable pressure sensitive adhesive composition, wherein the aliphatic polyester polyurethane is substantially free of crystallinity at the application temperature of about −10° C.-50° C.

The inventive disclosure includes the compostable pressure sensitive adhesive composition, wherein the aliphatic polyester polyurethane (PPU) aqueous dispersion is an anionic aliphatic polyester polyurethane (PPU) aqueous dispersion.

The inventive disclosure includes the compostable pressure sensitive adhesive composition, wherein the aliphatic polyester polyurethane is present in an amount from about 20 wt. % to about 60 wt. % of the composition.

The inventive disclosure includes the compostable pressure sensitive adhesive composition, wherein the rosin or rosin ester tackifier is present in an amount from about 5 wt. % to about 50 wt. % of the composition.

The inventive disclosure includes the compostable pressure sensitive adhesive composition, further including a plasticizer.

The inventive disclosure includes the compostable pressure sensitive adhesive, wherein the plasticizer is a polycaprolactone oligomer.

The inventive disclosure includes a compostable pressure sensitive adhesive composition made by the process of combining: (1) an aliphatic polyester polyurethane (PPU) aqueous dispersion including from about 20 wt. % to about 80 wt. % of an aliphatic polyester polyurethane made from an aliphatic polyol and an aliphatic isocyanate, the aliphatic polyester polyurethane having a molecular weight of from about 10,000 to about 1 M and a Tg less than about −10° C.; the aliphatic polyester polyurethane being substantially amorphous at the application temperature of the aliphatic polyester polyurethane (PPU) aqueous dispersion to a substrate; and (2) from about 5 wt. % to about 50 wt. % of a biodegradable rosin ester tackifier; wherein the biodegradable pressure sensitive adhesive composition is at least 90% biodegradable after being contained in an enclosure which is incubated in the dark or in diffuse light for 365 days or less at a temperature from about 19° C. to about 26° C. or for 180 days at a temperature from about 56° C. to about 60° C.

The inventive process may optionally further include combining a plasticizer with the aliphatic polyester polyurethane (PPU) dispersion and with the biodegradable rosin or rosin ester tackifier.

The inventive disclosure includes the compostable pressure sensitive adhesive formed, wherein the compostable pressure sensitive adhesive has a peel strength of from about 0.5 pounds per linear inch at room temperature to about 1.3 pounds per linear inch at room temperature.

The inventive disclosure includes the compostable pressure sensitive adhesive formed, wherein the aliphatic polyester polyurethane is substantially free of crystallinity at the application temperature.

The inventive disclosure includes the compostable pressure sensitive adhesive formed, wherein the aliphatic polyester polyurethane (PPU) aqueous dispersion is an anionic aliphatic polyester polyurethane (PPU) aqueous dispersion.

The inventive disclosure includes the compostable pressure sensitive adhesive formed, further comprising a plasticizer.

The inventive disclosure includes the compostable pressure sensitive adhesive formed, wherein the plasticizer is a polycaprolactone oligomer.

The inventive disclosure includes a biodegradable label including: (1) a biodegradable substrate; and (2) a compostable pressure sensitive adhesive composition prepared from: (i) an aliphatic polyester polyurethane (PPU) aqueous dispersion including an aliphatic polyester polyurethane made from the reaction of an aliphatic polyol and an aliphatic isocyanate, the aliphatic polyester polyurethane having a molecular weight of from about 10,000 to about 1 M and a Tg less than about −10° C.; the aliphatic polyester polyurethane being substantially amorphous at the application temperature of the aliphatic polyester (PPU) dispersion to a substrate; and (ii) a biodegradable rosin or rosin ester tackifier, wherein the biodegradable rosin ester tackifier is present in an amount sufficient to provide a peel strength of at least about 0.5 pounds per linear inch at room temperature; and wherein the compostable adhesive composition is at least 90% biodegradable after being contained in an enclosure which is incubated in the dark or in diffuse light for 365 days or less at a temperature from about 19° C. to about 26° C. or for 180 days at a temperature from about 56° C. to about 60° C.

The inventive disclosure includes the biodegradable label, wherein the compostable pressure sensitive adhesive composition further includes a plasticizer.

The inventive disclosure includes a method of making a biodegradable label including: (1) providing a biodegradable substrate; and (2) providing a compostable pressure sensitive adhesive composition prepared from: (i) an aliphatic polyester polyurethane (PPU) aqueous dispersion including an aliphatic polyester polyurethane made from the reaction of an aliphatic polyol and an aliphatic isocyanate, the aliphatic polyester polyurethane having a molecular weight of from about 10,000 to about 1 M and a Tg less than about −10° C.; the aliphatic polyester polyurethane being substantially amorphous at the application temperature of the aliphatic polyester polyurethane (PPU) aqueous dispersion to the biodegradable substrate; and (ii) a biodegradable rosin or rosin ester tackifier, wherein the biodegradable tackifier is present in an amount sufficient to provide a peel strength of at least about 0.5 pounds per linear inch at room temperature; and wherein the compostable adhesive composition is at least 90% biodegradable after being contained in an enclosure which is incubated in the dark or in diffuse light for 365 days or less at a temperature from about 19° C. to about 26° C. or for 180 days at a temperature from about 56° C. to about 60° C.; and (3) applying the compostable adhesive composition to the biodegradable substrate.

The inventive disclosure includes the method, wherein the compostable pressure sensitive adhesive composition further includes a plasticizer.

In general, unless otherwise explicitly stated the disclosed materials and processes may be alternately formulated to comprise, consist of, or consist essentially of, any appropriate components, moieties or steps herein disclosed. The disclosed materials and processes may additionally, or alternatively, be formulated so as to be devoid, or substantially free, of any components, materials, ingredients, adjuvants, moieties, species and steps used in the prior art compositions or that are otherwise not necessary to the achievement of the function and/or objective of the present disclosure.

These and other features and advantages of this disclosure will become more apparent to those skilled in the art from the detailed description of a preferred embodiment.

### DETAILED DESCRIPTION OF THE INVENTION

The singular forms “a”, “an” and “the” include plural referents unless the context clearly dictates otherwise.

About or “approximately” as used herein in connection with a numerical value refer to the numerical value ±10%, preferably ±5% and more preferably ±1% or less.

As used herein amounts are in parts by weight. If an amount is shown in parenthesis that is the dry weight. Dry wt. is the weight of that component but excluding any water. Dry wt. % is the wt. % of that component based on the weight of total adhesive excluding all water either in any of the components or separately added.

The terms “comprising” and “comprises” as used herein are synonymous with “including”, “includes”, “containing” or “contains”, and are inclusive or open-ended and do not exclude additional, non-recited members, elements or method steps.

At least one, as used herein, means 1 or more, i.e., 1, 2, 3, 4, 5, 6, 7, 8, 9, or more. With reference to an ingredient, the indication refers to the type of ingredient and not to the absolute number of molecules. “At least one polymer” thus means, for example, at least one type of polymer, i.e., that one type of polymer or a mixture of several different polymers may be used.

As used herein, the glass transition temperature (Tg) of the polyester polyurethane is the temperature at which the polyester polyurethane becomes brittle on cooling or soft on heating. More specifically, Tg defines a pseudo second order phase transition in which a polyester polyurethane yields, on cooling, a glassy structure with properties similar to those of a crystalline material. Above Tg, the aliphatic polyester polyurethane becomes soft and capable of plastic deformation without fracture. While the Tg is occasionally described as the “softening temperature” of a polymer, it is not uncommon for the polymer to begin softening at a temperature below the Tg. This is because, due to the nature of many non-crystalline polymers, the softening of the polymer may occur over a temperature range rather than abruptly at a single temperature value. Tg generally refers to the middle point of this range even though the polymer may begin to soften at a different temperature. For purposes of this application, the Tg of a polyester polyurethane refers to the value as determined generally following ASTM E-1356 by Differential Scanning calorimetry at a scanning rate of 10 C/min.

When amounts, concentrations, dimensions and other parameters are expressed in the form of a range, a preferable range, an upper limit value, a lower limit value or preferable upper and lower limit values, it should be understood that any ranges obtainable by combining any upper limit or preferable value with any lower limit or preferable value or any value intermediate the upper and lower limit values are also specifically disclosed, irrespective of whether the obtained ranges are clearly mentioned in the context.

Preferred and preferably are used frequently herein to refer to embodiments of the disclosure that may afford particular benefits, under certain circumstances. However, the recitation of one or more preferable or preferred embodiments does not imply that other embodiments are not useful and is not intended to exclude those other embodiments from the scope of the disclosure.

Unless specifically noted, throughout the present specification and claims the term molecular weight when referring to a polymer refers to the polymer's number average molecular weight (Mn). The number average molecular weight Mₙ can be calculated based on end group analysis (OH numbers according to DIN EN ISO 4629, free NCO content according to EN ISO 11909) or can be determined by gel permeation chromatography according to DIN 55672 with THF as the eluent. If not stated otherwise, all given molecular weights are those determined by gel permeation chromatography.

There are numerous definitions and standards for different aspects of biodegradation and compostability. Some standards include Biodegradible Products Institute (BPI), BPI Certification Scheme, Compostable products, resins, and intermediates according to ASTM D6400 and ASTM D6868; European Standard EN 14046, Evaluation of the ultimate aerobic biodegradability and disintegration of packaging materials under controlled composting conditions, Method by analysis of released carbon dioxide; ASTM D5338, Standard Test Method for Determining Aerobic Biodegradation of Plastic Materials Under Controlled Composting Conditions, Incorporating Thermophilic Temperature; ASTM D6400-12, Standard Specification for Labeling of Plastics Designed to be Aerobically Composted in Municipal or Industrial Facilities; Standards Australia AS 5810:2010, Biodegradable plastic—Biodegradable plastics suitable for home composting; and Organization for Economic Co-operation and Development (OECD) 301B and 301C, Modified MITI test—Ready degradability test) Chemical substance—Aerobic biodegradability test by activated sludge JIS K 6950.

Most relevant for this document is European Standard EN 13432, which defines the characteristics a material must have in order to be claimed as “compostable” and, therefore, be recycled through composting of organic solid waste in an industrial setting. EN 13432, evaluates four criteria to determine compostability. These criteria include: biodegradibillity, disintegrability, compost quality or ecotoxicity, and chemical characteristics.

Biodegradability under EN 13432 is the ability of the compostable material to be converted into CO₂ under the action of microorganisms. ISO 14855 (compost test medium) and ISO 14851 or ISO 14852 (liquid test mediums) are recommended as a laboratory test method to determine biodegradability. In order to show complete biodegradability, a biodegradation level of at least 90% must be reached in less than six months. ISO 14855 is ISO 14855-2:2018, Determination of the ultimate aerobic biodegradability of plastic materials under controlled composting conditions. . . . ISO 14851 is ISO 14851:2019, Determination of the ultimate aerobic biodegradability of plastic materials in an aqueous medium. . . ISO 14852 is ISO 14852:2021, Determination of the ultimate aerobic biodegradability of plastic materials in an aqueous medium. ISO standards are available from https://www.iso.org/standard.

Disintegrability under EN 13432 refers to fragmentation and loss of visibility in the final compost (absence of visual pollution). EN 13432 recommends assessment of disintegration through trials. Specimens on the test materials are composted with biowaste for three months. The final compost is then screened with a 2 mm sieve. The mass of test material residues with dimension >2 mm shall be less than 10% of the original mass.

Compost quality or ecotoxicity under EN 13432 refers to the packaging waste not having a negative impact on the quality of compost.

Chemical characteristics under EN 13432 refers to verify compost samples generated in trials are within safe levels for heavy metals (such as Hg, Cd, Cu, Cr and Zn), fluorine and other chemical characteristics requirement.

TÜV AUSTRIA BELGIUM NV/SA (TUV AUSTRIA) provides certification that products are industrially compostable (OK compost industrial) or home compostable (OK compost home). Industrial compostability testing follows EN 13432. Home compostability testing follows a modified version of EN 13432 with disintegrability defined after a 180-day period with no more than 10% of original dry weight of the test material failing to pass through a 2 mm sieve and biodegradability defined as 90% of the organic carbon being converted to CO₂ after a test period of 365 days. The test temperature for home compostability is between 20-30° C., while temperature for industrial compostability is between 56-60° C.

The EN 13432 and the TUV AUSTRIA standards and tests will be referenced in this document unless otherwise stated. It should be understood that these standards are similar in many ways to other compostability standards and test. It is believed that PSA adhesives that are compostable under the EN 13432 and the TUV AUSTRIA standards and tests are likely compostable under other compostability standards such as described above.

Although a PSA typically makes up less than 10% by weight of total label or packaging it prevents or hinders composting the entire label. Thus, making PSA compostable or mostly biodegradable will improve the compostability of the overall label or packaging.

This disclosure addresses the need for compostable pressure sensitive adhesives by providing a compostable or mostly biodegradable pressure sensitive adhesive that can be used in food labels and packaging, such as fruit or produce labels. This PSA and label it is applied to can be composted along with organic solid waste, without hindering the composting process or compromising the compost quality. In particular, the disclosure utilizes biodegradable polyurethane dispersions that are easy to manufacture, safe to coat and offer compostability and desirable PSA performance.

It has unexpectedly been found that compostability and PSA performance can be achieved when a polyester polyurethane (PPU) dispersion and a biodegradable tackifier as disclosed herein are combined in amounts as disclosed herein.

The inventive disclosure includes biodegradable pressure sensitive adhesive compositions including at least one polyester polyurethane (PPU) dispersion including a polyester polyurethane and at least one biodegradable tackifier.

The inventive disclosure includes compostable pressure sensitive adhesive compositions including a polyester polyurethane (PPU) dispersion including a polyester polyurethane and a biodegradable rosin ester tackifier.

This disclosure includes a pressure sensitive adhesive that is compostable or substantially biodegradable, based on a biodegradable polyurethane dispersion, a tackifier and optionally a plasticizer. The biodegradable polyurethane is the reaction product of an aliphatic polyester polyol with an isocyanate. These polyurethanes are typically developed for coating and generally do not have any tack or pressure sensitive properties.

In addition to compositability, the pressure sensitive adhesive compositions are advantageous in not having volatile organic compounds (VOC).

The pressure sensitive adhesive compositions of the disclosure are at least 50% biodegradable, preferably at least 60% biodegradable, more preferably at least 70% biodegradable, even more preferaby at least 80% biodegradable and most preferably at least 90% biodegradable. When the pressure sensitive adhesive compositions of the disclosure are at least 90% biodegradable and the other criteria of EN 13432 or TUV AUSTRIA are met the pressure sensitive adhesive compositions of the disclosure are compostable.

The pressure sensitive adhesive composition of the disclosure is at least 50% biodegradable when at least 50% of organic carbon in the pressure sensitive adhesive is converted into carbon dioxide (CO)₂ at conditions specified in EN 13432 or TUV AUSTRIA OK compost (industrial) or TUV AUSTRIA OK compost (home).

The pressure sensitive adhesive composition of the disclosure is at least 60% biodegradable when at least 60% of organic carbon in the pressure sensitive adhesive is converted into carbon dioxide (CO)₂ at conditions specified in EN 13432 or TUV AUSTRIA OK compost (industrial) or TUV AUSTRIA OK compost (home).

The pressure sensitive adhesive composition of the disclosure is at least 70% biodegradable when at least 70% of organic carbon in the pressure sensitive adhesive is converted into carbon dioxide (CO)₂ at conditions specified in EN 13432 or TUV AUSTRIA OK compost (industrial) or TUV AUSTRIA OK compost (home).

The pressure sensitive adhesive composition of the disclosure is at least 80% biodegradable when at least 80% of organic carbon in the pressure sensitive adhesive is converted into carbon dioxide (CO)₂ at conditions specified in EN 13432 or TUV AUSTRIA OK compost (industrial) or TUV AUSTRIA OK compost (home).

The pressure sensitive adhesive composition of the disclosure is at least 90% biodegradable when at least 90% of organic carbon in the pressure sensitive adhesive is converted into carbon dioxide (CO)₂ at conditions specified in EN 13432 or TUV AUSTRIA OK compost (industrial) or TUV AUSTRIA OK compost (home).

This disclosure includes a pressure sensitive adhesive which is compostable. In an aspect of the disclosure, a pressure sensitive adhesive composition of the disclosure is compostable when at least 90% of organic carbon in the pressure sensitive adhesive is converted into CO₂ under composting conditions.

In an aspect of the disclosure, a pressure sensitive is compostable when the pressure sensitive adhesive is tested at conditions specified in ASTM D6400 or EN 13432 or TUV AUSTRIA OK compost (industrial) or TUV AUSTRIA OK compost (home) or EN14046 or ASTM D5338 or ISO 14851 or ISO 14852 or ISO 14855 or OECD 301B or OECD 301C or ASTM D 6691 or AS 5810:2010.

In an aspect of the disclosure, a pressure sensitive adhesive is certified compostable when the pressure sensitive adhesive is tested at conditions specified in EN 13432 or TUV AUSTRIA OK compost (industrial) or TUV AUSTRIA OK compost (home).

In an aspect of the disclosure, a pressure sensitive adhesive is home compostable when the pressure sensitive adhesive is tested at conditions specified in AS 5810:2010 or TUV Austria OK Compost (home).

The percentage of organic carbon in the pressure sensitive adhesive which is converted to CO₂ can be determined using any method known in the art for determining evolved carbon dioxide. Such methods for determining evolved carbon dioxide includes DIC measurement and a titrimetric method using a barium hydroxide solution as set forth in Annex B of ISO 14852:2018(E).

The polyester polyurethane can be any suitable polyester polyurethane known in the art and can have any biodegradable backbone. Preferably, the polyester polyurethane is an aliphatic polyester polyurethane. The biodegradable polyurethane prepolymer is preferably the reaction product of an aliphatic polyester polyol with isocyanate. These products are typically developed for coating and do not have any tack or pressure sensitive properties. It is important that the aliphatic polyester polyol has a high affinity to water. Aliphatic isocyanates are also preferred for use in the biodegradable polyurethane prepolymer. Without wishing to be bound to any particular theory, aromatic isocyanates may slow down biodegradation by creating steric problems for microbes.

The polyester polyurethane has a Tg which is much lower than room temperature. Preferably, the polyester polyurethane has a Tg which is less than −10° C. It is particularly useful when the polyester polyurethane has a Tg which is less than −10° C.

Useful aliphatic polyester polyols include, for example, polyether polyols, polyester polyols, polybutadiene polyols, polycarbonate polyols, polyacetal polyols, polyamide polyols, polyesteramide polyols, polyalkylene polyether poly-ols, polythioether polyols and mixtures thereof; preferably polyether polyols, polyester polyols, polycarbonate polyols and mixtures thereof; and more preferably polyester polyols, polyether polyols and combinations thereof.

The aliphatic polyester polyurethane can have any suitable molecular weight. Preferably, the aliphatic polyester polyurethane has a molecular weight from about 10,000 to about 1 M.

Useful isocyanates include, for example, an aliphatic polyisocyanate such as hexamethylene diisocyanate (hereinafter referred to as HDI); an alicyclic polyisocyanate such as isophorone diisocyanate (hereinafter referred to as IPDI) or 4,4′-methylenebis (cyclohexyl isocyanate); an isocyanate functional oligomer or prepolymer; or a modified product such as an urethane modified product, an allophanate modified product, a carbodiimide modified product or an isocyanurate modified product; in each case obtainable from an aliphatic polyisocyanate. Particularly preferred are aliphatic polyisocyanates having two isocyanate groups, such as hexamethylene diisocyanate (HDI), isophorone diisocyanate IPDI), methylene dicyclohexyl diisocyanate or hydrogenated MDI (HMDI).

Preferably, the aliphatic polyester polyester polyurethane has a molecular weight from about 10,000 to about 1 M and has a Tg of less than about −10° C.

The polyester polyurethane can be any useful form such as polyurethane hotmelt adhesive, polyurethane moisture curable liquid adhesive; two component polyurethane adhesive; reactive polyurethane hotmelt adhesive and solvent based polyurethane adhesive. Preferably, the polyeter polyurethane is an aqueous polyurethane dispersion as known in the art. The polyester polyurethane dispersion can be a polyester polyurethane (PPU) aqueous dispersion. The polyester polyurethane (PPU) dispersion can be anionic. It is useful when the polyester polyurethane (PPU) dispersion is aliphatic. It is also useful when the polyester polyurethane (PPU) dispersion is biodegradable. Preferably, the polyester polyurethane (PPU) dispersion is an aliphatic polyester polyurethane (PPU) aqueous dispersion. The polyester polyurethane (PPU) dispersion can be an aliphatic polyester polyurethane (PPU) aqueous dispersion which is anionic.

Useful aliphatic polyester polyurethane dispersions include, for example, Impranil® DLN-SD and Dispercoll U XP, which are each an anionic polyester polyol polyurethane aqueous dispersion from Covestro. Impranil® DLN-SD has been reported to be 40% biodegradable. However, the Impranil DLN-SD is not further biodegradable and not compostable. Another useful dispersion from Covestro is Dispercoll® U 2682, which is “a waterborne dispersion of an anionically modified polyurethane for application in compostable flexible lamination adhesives.” Another useful aliphatic polyester polyurethane dispersion is Epotal® ECO 3702, which is an aqueous dispersion of a polyester-polyurethane elastomer available from BASF.

The polyester polyurethane dispersion (PURD) can be present in the pressure sensitive adhesive composition in any suitable amount. It is useful when the polyester polyurethane dispersion (PUR) is present in the pressure sensitive adhesive composition in an amount from about 5 dry wt. % to about 60 dry wt. %. It is particularly useful when the polyester polyurethane dispersion is present in the pressure sensitive adhesive composition in an amount from about 30-55 dry wt. %, preferably 40-50 dry wt. %.

The tackifier can be any suitable biodegradable tackifier. Preferably, the biodegradable tackifier is a biodegradable rosin or rosin ester. The rosin ester is preferably from about 40% to about 60% biodegradable and more prefereably about 60 to about 90% biodegradable. The percentage of biodegradability of the rosin ester is determined by OECD 301B or ISO 14852. The tackifier can be selected from easily biodegradable sources such as rosin, rosin soap, rosin ester. Useful tackifiers include rosin soap such as Sylvaros™ DRS 40, DRS 42, DRS 200, DRS 214 and DRS 731, available from Kraton Corporation. Other rosin materials include Dresinate rosin soap from Eastman (for example Dresinate 91, 91-44WL, TX, TX-60W) and rosin ester water dispersions such as Aquatac 6025, 6085, 6180, 2685, 2600 available from Kraton Corporation.

The tackifier can optionally be used in the pressure sensitive adhesive composition in any suitable amount. It is useful when the tackifier is present in the pressure sensitive adhesive composition in an amount from about 5 to 50 dry wt. %, preferably 5 to 20 dry wt. %.

The biodegradable pressure sensitive adhesive composition may optionally include at least one plasticizer. Preferably, the at least one plasticizer may be chosen from biodegradable materials such as polycaprolactone oligomers, polypropylene glycol (PPG) and polyethylene glycol (PEG) of a certain molecular weight such as polyethylene glycol 400 (PEG 400) and polyethylene glycol 600 (PEG 600). Polyglycolic acid (PGA) may also be useful as a plasticizer. The melting point of the plasticizer must be low so that the plasticizer does not crystallize. The plasticizer may have a melting point less than about 20° C. and/or a molecular weight above about 500. When PGA is used as a plasticizer, the melting point is below 25° C. The plasticizer is preferaby a polycaprolactone oligomer. Examples of suitable plasticizers include Capa polyols, such as CAPA 3050J (molecular weight of 540 g/mol; melting point of 0-10° C.), Capa 3091 (molecular weight of 920 g/mol; melting point of 0-10° C.) and Capa 4101 (molecular weight of 1000; melting point of −20° C.), which are Capa® caprolactones available from Ingevity. Other plasticizers may be useful including other Capa® Caprolactones available from Ingevity which are disclosed in Product Portfolio, Capa® Caprolactones, by Ingevity, the entire contents of which are incorporated by reference herein.

A plasticizer can be present in the pressure sensitive adhesive composition in any suitable amount. It is useful when the plasticizer is present in the pressure sensitive adhesive composition in an amount from about 5 dry wt. % to 50 dry wt. %. It is particularly useful when the plasticizer is present in the composition in an amount from about 20 dry wt. % to 50 dry wt. %, preferably about 35 dry wt. % to 45 dry wt. %.

Other additives typically used in water-based PSA such as as defoamer, wetting agent and biocide can also be used as needed. To help pass biodegradability test requirements, other additives with high biodegradability, such as starch and its derivatives, dextran, cellulose and its deriviatives, and sodium benzoate, for example, can also be added to the formulation. A suitable defoamer is Tego® Antifoam 2-89, which is an antifoam emulsion based on polyethersiloxane and which is available from Evonik. A suitable wetting agent is Surfynol® 440 which available from Evonik.

The adhesive composition and all components therein are preferably substantially amorphous at the application temperature of the pressure sensitive adhesive composition to a substrate. As used herein, “substantially amorphous” means that the dried adhesive composition has 10% or less crystallinity, preferably 5% or less crystallinity, more preferably 3% or less crystallinity and even more preferably 1% or less crystallinity at the application temperature of the pressure sensitive adhesive composition to a substrate (application temperatures are typically within the range of about 5° C. to about 70° C.). Ideally, the dried adhesive composition is completely free of crystallinity at the application temperature. Crystallinity can be measured using differential scanning calorimetry. See Determination of Polymer Crystallinity by DSC; Roger L. Blaine, Ph.D.; TA Instruments. Using this test, the crystalline peak is within the temperature range of about 0° C. to about 100° C., preferably about 5° C. to about 70° C., and the enthalpy of the DSC peak is preferably less than 5 J/g of dried adhesive composition.

The pressure sensitive adhesive composition should provide a peel strength of at least about 6 oz/inch² (0.375 lbs/inch²). Preferably, the tackifier can be present in the pressure sensitive adhesive composition in an amount sufficient to provide a peel strength of from about 0.5 pounds per linear inch (8 ounces per linear inch) at room temperature to about 1.3 pounds per linear inch (20.8 ounces per linear inch) at room temperature.

The pressure sensitive adhesives of the disclosure have a peel strength of at least about 6 oz/inch² (0.375 lbs/inch²). Preferably, the pressure sensitive adhesives of the disclosure have a peel strength of from about 0.5 pounds per linear inch (8 ounces per linear inch) at room temperature to about 1.3 pounds per linear inch (20.8 ounces per linear inch) at room temperature.

Peel strength, loop tack and shear strength of the disclosed pressure sensitive adhesives can be measured using known test methods such as Test Methods for Pressure Sensitive Adhesive Tapes; Pressure Sensitive Tape Council; Chicago, IL 60604 USA. Typically, an aqueous adhesive composition is coated on general-purpose lab liner, dried at 250 F. for five minutes and the dried sample is laminated to a 2 mil polyester substrate. The adhesive is cut to a desired size, typically 6″ long by 1″ wide, (peel test strip), ½″ wide by 3″ long (shear test strip), 1″ wide by 5″ long (loop tack strip) The prepared samples are maintained for 24 hours at 72° F. and 50% relative humidity before testing.

Peel adhesion measures the force required to peel a sample of adhesive from a steel panel at a 180° angle. The test was run at 12 inches per minute using the above SS/adhesive

Shear is measured by adhering a piece of tape to a stainless steel panel, then hanging a weight on one end of the tape. Shear is expressed in units of time prior to the tape slipping from the steel panel. Shear strength was measured at 72° F. after conditioning the adhesive for 24 hours at 72° F./50% relative humidity on stainless steel. Shear test conditions were:
2.2 psi (1″ long×½″ wide adhesive; 500 g weight)
4.4 psi (1″ long×½″ wide adhesive; 1,000 g weight)
8.8 psi (1″ long×½″ wide adhesive; 2,000 g weight)
   Loop Tack on stainless steel can be conditioned at 72° F./50% relative humidity.

In the loop tack test a loop is created from the test material with the adhesive coated side to contact the substrate or stainless steel plate. The ends are clamped together in an upper grip. The loop is pushed onto a surface, compressing the adhesive. Then the loop is pulled up and gradually debonds from the substrate or plate. The force required to remove the loop from the substrate is the loop tack measurement. Loop tack was measured after conditioning the specimens.

In one embodiment typically used with heat sensitive materials the aqueous adhesive composition is applied at room temperature or slightly below room temperature onto a surface of a release layer. The applied adhesive is heated to remove water, leaving a 0.0005 inch (0.5 mil) to 0.003 inch (3 mil) layer of dried PSA adhesive on the release liner. Once dried the PSA adhesive is cut to size and transferred to a substrate such as a label. In another embodiment typically used with less heat sensitive materials the aqueous adhesive composition is applied to a substrate such as a paper label or compostable label. The applied adhesive and substrate is heated to remove water, leaving a 0.0005 inch (0.5 mil) to 0.003 inch (3 mil) layer of dried PSA adhesive on the label. Once dried the label with applied PSA adhesive is cut to size and transferred to a container. In any embodiment the pressure sensitive adhesives of the disclosure can be used as a PSA adhesive for a fruit and produce label, a food packaging label or a label on paper or other compostable substrate.

The pressure sensitive adhesives of the disclosure are preferably not hot melt adhesives.

### EXAMPLES

### Example 1

The samples were prepared by adding the specified amount of each material to a standard blender and mixing until homogeneous, about 1 hour. All amounts are in parts with dry parts shown in parenthesis.

This example provides examples of inventive pressure sensitive adhesive compositions and demonstrates how better PSA performance such as high peel, tack and shear can be achieved by using a polyester polyurethane dispersion with a glass transition temperature of −54C. Inventive pressure sensitive adhesive compositions PSA 1, PSA 2, PSA 3 and PSA 4 were made from formulations as set forth in Table 1.

TABLE 1

| Ingredient | PSA 1 | PSA 2 | PSA 3 | PSA 4 |
|---|---|---|---|---|
| Impranil ® DLN-SD¹ (40% | 40 (16) | 0 | 0 | 0 |
| solids) | | | | |
| Dispercoll ® U XP 2682² (50% | 0 | 40 (20) | 0 | 0 |
| solids) | | | | |
| Epitol ® ECO 3702³ (40% | 0 | 0 | 40 (16) | 0 |
| solids) | | | | |
| Bayhydrol U2891⁴ (40%) | 0 | 0 | 0 | 40 |
| Sylvaros DRS 40⁵ (80% solids) | 10 (8) | 12.5 (10) | 10 (8) | 10 (8) |
| CAPA 4101⁶ | 16 | 20 | 16 | 16 |
| Water | 30 | 50 | 50.5 | 25 |
| Surfynol ® PSA 336⁷ | 0 | 2.0 | 5 | 0 |
| Stainless Steel 180° Peel | 7.12 | 0.11 | 0.10 | 0.10 |
| (ozf/in) | | | | |
| Loop Tack (ozf/in) | 17.43 | 0.22 | 0.24 | 0.35 |
| Shear (h) ½″ × 1″ × 500 g/RT | 0.08 | 0 | 0 | 0 |
| (2.2 psi) | | | | |

¹Anionic polyester polyol polyurethane dispersion from Covestro and having a Tg of −54° C.
²Anionic polyester polyol polyurethane dispersion from Covestro and having a Tg of −48° C.
³Aqueous dispersion of a polyester polyurethane elastomer from BASF and having a Tg of −49° C.
⁴Anionic polyester polyol polyurethane dispersion from Covestro and having a Tg of −51° C.
⁵Rosin soap tackifier available from Kraton Corporation.
⁶Capa ® Caprolactone (1000 MW (g/mol); mp 0-10° C.) plasticizer available from Ingevity.
⁷Surfactant from Evonik.

While compositions of PSA 1 to 4 were similar, PSA 1 had surprisingly better adhesive properties. The preferred biodegradable polyurethane dispersion is the one with the lower glass transition temperature, i.e., Impranil® DLN-SD, which is used in the formulation for PSA 1.

### Example 2

The samples were prepared by adding the specified amount of each material to a standard blender and mixing until homogeneous, about 1 hour. All amounts are in parts with dry parts shown in parenthesis.

TABLE 2

| Ingredient | PSA 5 | PSA 6 | C 1 |
|---|---|---|---|
| Impranil DLN-SD (40% solids)¹ | 100 (40) | 100 (40) | 110 (44) |
| Sylvaros DRS 40 (80% solids)² | 15 (12) | 25 (20) | 25 (20) |
| CAPA 4101³ | 40 | 40 | 30 |
| Water | 30 | 0 | 0 |
| Surfynol ® 440⁴ | 0.2 | 0.5 | 0.5 |
| Tego 2-89⁵ | 0.1 | 0.1 | 0.1 |
| Stainless Steel 180° Peel (ozf/in) | 15.3 | 20.6 | No peel |
| Loop Tack (ozf/in) | 27.6 | 15.5 | No tack |
| Shear (hours) ½″ × 1″ × 500 g/RT | 0.03 | 0.01 | not |
| (2.2 psi) | | | measured |

¹Anionic polyester polyol polyurethane dispersion from Covestro and having a Tg of −5 C.
²Rosin soap tackifier available from Kraton Corporation.
³Capa ® Caprolactone (1000 MW (g/mol); mp 0-10° C.).
⁴Wetting agent available from Evonik.
⁵Antifoam emulsion based on polyethersiloxane and available from Evonik.

Example 2 demonstrates how the performance of a pressure sensitive adhesive (PSA) based on a PUR dispersion is surprisingly dependent on the amount of tackifier and plasticizer used in the adhesive composition. For each pressure sensitive adhesive composition there is an optimum range for each component to obtain maximum tack and peel strength. Surprisingly adding tackifier as shown in samples PSA 5 and 6 can reduce tack. Also, surprisingly, reducing the amount of plasticizer as shown in comparative sample C 1 can reduce tack and peel to unmeasurable levels.

### Example 3

The samples were prepared by adding the specified amount of each material to a standard blender and mixing until homogeneous, about 1 hour. All amounts are in parts with dry parts shown in parenthesis.

TABLE 3

| Ingredient | C 2 | PSA 7 |
|---|---|---|
| Impranil ® DLN-SD (40% s) ¹ | 100 (40) | 100 (40) |
| Sylvaros ® DRS 40 (80% s) ² | 0 | 15 (12) |
| Tacolyn ™ 1070 (60% s) ³ | 14.2 (8.5) | 0 |
| CAPA 3050J⁴ | 38.33 | 0 |
| CAPA 4101⁵ | 0 | 40 |
| Water | 5.00 | 0 |
| Tego ® 2-89⁶ | 0.024 | 0 |
| 60° C. in vessel composability test⁷ | 50% remaining | Expected to pass |
| Iso 14852 CO₂ conversion in 8 weeks | 40% | 85% |

¹ Anionic polyester polyol polyurethane dispersion from Covestro and having a Tg of −54.
² Rosin soap tackifier available from Kraton Corporation.
³ Hydrocarbon resin dispersion available from Eastman.
⁴Capa ® Caprolactone (540 MW (g/mol); mp 0-10° C.) plasticizer available from Ingevity.
⁵Capa ® Caprolactone (1000 MW (g/mol); mp 0-10° C.) plasticizer available from Ingevity.
⁶Antifoam emulsion based on polyethersiloxane available from Evonik.
⁷In the vessel composability test, C #2 was placed in a compostability vessel for 6 weeks at a temperature of 60° C. After 6 weeks, disintegration (i.e., loss of physical form) and CO₂ conversion (i.e., the amount of organic carbon converted to CO₂) were measured. This is a specific test offered by CMA (compost manufacturing alliance) to check the compostability in industrial compost environment. https://compostmanufacturingalliance.com/testing/

Example 3 shows comparative sample C 2 where compostability is not achieved when a hydrocarbon resin dispersion which is not readily biodegradable is used. This example also provides inventive sample PSA 7 where compostability is expected to be achieved when a rosin soap tackifier that is 90% biodegradable and a polycaprolactone oligomer that is compostable are used. As shown in Table 3, comparative sample C 2 is made from a formulation including Tacolyn 1070, a hydrocarbon resin dispersion, which is not readily biodegradable. As is further apparent from Table 3, sample PSA 7 is made from a formulation which includes Sylvaros DRS 40, which is a rosin soap that is 90% biodegradable. As is also apparent from Table 3, sample PSA 7 also includes CAPA 4101, which is a polycaprolactone oligomer which is also compostable. Sample PSA 7 is expected to pass a 60° C. in vessel composability test. However, comparative sample C 2 did not pass a 60° C. in vessel composability test because the CO₂ conversion as determined in accordance with testing at conditions specified in ISO 14852 was less than 90%, i.e., 90% of organic carbon in PSA #1 was not converted to CO₂. The CO₂ conversion of sample PSA 7 is 85% in 8 weeks by ISO 14852. This adhesive is expected to easily pass 90% CO2 conversion within 12 months, as required for home compostable by TUV Austria.

### Example 4

The samples were prepared by adding the specified amount of each material to a standard blender and mixing until homogeneous, about 1 hour. All amounts are in parts with dry parts shown in parenthesis.

TABLE 4

| Ingredient | PSA 8 | PSA 9 | PSA 10 |
|---|---|---|---|
| Impranil ® DLN-SD¹ (40% | 40 (16) | 40 (16) | 40 (16) |
| solids) | | | |
| Sylvaros DRS 40² (80% solids) | 6 (4.8) | | |
| Sylvaros DRS 42³ (80% solids) | | 6 (4.8) | |
| Sylvaros DRS 731⁴ (70% | | | 6.86 (4.8) |
| solids) | | | |
| CAPA 4101⁵ | 16 | 16 | 16 |
| Water | 30 | 30 | 30 |
| Stability @ 30 days | gelled | gelled | stable |
| Stability @ 60 days | gelled | gelled | stable |

¹Anionic polyester polyol polyurethane dispersion from Covestro and having a Tg of −54° C.
²Rosin soap tackifier available from Kraton Corporation.
³Rosin soap tackifier available from Kraton Corporation.
⁴Rosin soap tackifier available from Kraton Corporation.
⁵Capa ® Caprolactone (1000 MW (g/mol); mp 0-10° C.) plasticizer available from Ingevity.

Example 4 shows only certain rosin tackifiers can maintain the required formulation stability. Sylvaros DRS 731 provides better stability over Sylvaros DRS 40 and 42. Estimated ISO 14852 CO₂ conversion of samples PSA 8 to 10 in 8 weeks is expected to be about 85%.

### Example 5

The samples were prepared by adding the specified amount of each material to a standard blender and mixing until homogeneous, about 1 hour. All amounts are in parts with dry parts shown in parenthesis.

TABLE 5

| Ingredient | PSA 11 | PSA 12 | PSA 13 |
|---|---|---|---|
| Impranil ® DLN-SD¹ (40% | 40 (16) | 40 (16) | 40 (16) |
| solids) | | | |
| Sylvaros DRS 40² (80% solids) | | 6 (4.8) | 6 (4.8) |
| Sylvaros DRS 731³ (70% | 6.86 (4.8) | | |
| solids) | | | |
| CAPA 4101⁴ | 16 | 16 | 16 |
| Water | 30 | 30 | 30 |
| Centex HA⁵ | 0 | 2 | 0 |
| Ammonium Hydroxide⁶ | 4.6 | 0 | 4.6 |
| Stability @ 30 days | stable | stable | stable |
| Stability @ 60 days | Phase | stable | Phase |
| | separated | | separated |

¹Anionic polyester polyol polyurethane dispersion from Covestro and having a Tg of −54° C.
²Rosin soap tackifier available from Kraton Corporation.
³Rosin soap tackifier available from Kraton Corporation.
⁴Capa ® Caprolactone (1000 MW (g/mol); mp 0-10° C.) plasticizer available from Ingevity.
⁵Natural rubber latex dispersion available from Centrotrade Rubber.
⁶26% available from Hydrite Chemical.

Example 5 shows that adding high ammonium content natural rubber latex and ammonium hydroxide to raise pH of the composition appears to improve storage stability. Estimated ISO 14852 CO2 conversion of samples PSA 11 to 13 in 8 weeks is expected to be about 85%.

What is claimed is:

1. A compostable, pressure sensitive adhesive prepared from a composition comprising:
an aliphatic polyester polyurethane (PPU) aqueous dispersion comprising an aliphatic polyester polyurethane made from an aliphatic polyol and an aliphatic isocyanate, said aliphatic polyester polyurethane having a molecular weight of from about 10,000 to about 1 M g/mol and a Tg less than about −10° C.; said aliphatic polyester polyurethane having 10% or less crystallinity; and
a biodegradable rosin ester tackifier, wherein the biodegradable rosin ester tackifier is present in an amount sufficient to provide a peel strength of at least about 0.5 pounds per linear inch at room temperature; and
wherein the pressure sensitive adhesive composition is is compostable when the pressure sensitive adhesive is tested at conditions specified under one or more of ASTM D6400 or EN 13432 or TUV AUSTRIA OK compost (industrial) or TUV AUSTRIA OK compost (home) or EN14046 or ASTM D5338 or ISO 14851 or ISO 14852 or ISO 14855 or OECD 301B or OECD 301C or ASTM D 6691 or AS 5810:2010.

2. The compostable pressure sensitive adhesive of claim 1, wherein the pressure sensitive adhesive composition is at least 50% biodegradable after being contained in an enclosure which is incubated in the dark or in diffuse light for 365 days or less at a temperature from about 20° C. to about 30° C. or for 180 days at a temperature from about 56° C. to about 60° C.

3. The compostable pressure sensitive adhesive of claim 1, wherein the pressure sensitive adhesive is at least 60% biodegradable, preferably 70% biodegradable, more preferably 80% biodegradable and even more preferably 90% biodegradable; in each case after being contained in an enclosure which is incubated in the dark or in diffuse light for 365 days or less at a temperature from about 20° C. to about 30° C. or for 180 days at a temperature from about 56° C. to about 60° C.

4. The compostable pressure sensitive adhesive composition of claim 1, wherein the rosin ester tackifier is present in an amount sufficient to provide a peel strength of from about 0.5 pounds per linear inch at room temperature to about 1.3 pounds per linear inch at room temperature.

5. The compostable pressure sensitive adhesive of claim 1, wherein the adhesive has 10% or less crystallinity, preferably 5% or less crystallinity, more preferably 3% or less crystallinity and even more preferably 1% or less crystallinity.

6. The compostable pressure sensitive adhesive composition of claim 1, wherein the aliphatic polyester polyurethane (PPU) aqueous dispersion is an anionic aliphatic polyester polyurethane (PPU) aqueous dispersion.

7. The compostable pressure sensitive adhesive composition of claim 1, wherein the aliphatic polyester polyurethane is present in an amount from about 20 wt. % to about 60 wt. % based on weight of the total composition.

8. The compostable pressure sensitive adhesive composition of claim 1, wherein the rosin ester tackifier is present in an amount from about 5 wt. % to about 50 wt. % based on weight of the total composition.

9. The compostable pressure sensitive adhesive composition of claim 1, further comprising a plasticizer, preferably the plasticizer is a polycaprolactone oligomer.

10. A biodegradable label comprising:
a biodegradable substrate; and
the compostable pressure sensitive adhesive of claim 1.
